(19) United States
(12) Patent Application Publication
(10) Pub. No.: US 2025/0002413 A1
(43) Pub. Date: Jan. 2, 2025

(54) SUPERHYDROPHOBIC SELF-LUMINOUS CONCRETE MATERIAL FOR 3D PRINTING AND METHOD FOR PREPARING SAME

(71) Applicant: SHANDONG UNIVERSITY, Jinan, Shandong (CN)

(72) Inventors: Zeying YANG, Jinan (CN); Hetao HOU, Jinan (CN); Ke WU, Jinan (CN); Rongrong DUAN, Jinan (CN); Jianbo QU, Jinan (CN); Endong WANG, Jinan (CN); Ping ZHANG, Jinan (CN); Qingwei MENG, Jinan (CN); Yuhui SHAN, Jinan (CN); Hongyun WANG, Jinan (CN); Xinxue GAO, Jinan (CN); Feng ZHAO, Jinan (CN); Li ZHAO, Jinan (CN); Weisong QU, Jinan (CN); Qianyi YANG, Jinan (CN); Rui SUN, Jinan (CN); Chuanlong BI, Jinan (CN); Zhilin QU, Jinan (CN); Chenghe WANG, Jinan (CN); Jie LIU, Jinan (CN); Zhenyu ZHAO, Jinan (CN); Guangtong ZHOU, Jinan (CN)

(73) Assignee: SHANDONG UNIVERSITY, Jinan, Shandong (CN)

(21) Appl. No.: 18/270,249

(22) PCT Filed: Feb. 7, 2023
(86) PCT No.: PCT/CN2023/074719

§ 371 Date: Jun. 29, 2023

(30) Foreign Application Priority Data
Sep. 5, 2022 (CN) 202211077772.6

(51) Int. Cl. C04B 28/06; C04B 14/06; C04B 14/10; C04B 14/30; C04B 16/06; C04B 18/14; C04B 24/38; C04B 24/40; C04B 41/49; C04B 41/64; C04B 103/30; C04B 103/50; C04B 103/54; C04B 111/00; C04B 111/80

(52) U.S. Cl. CPC C04B 28/06; C04B 14/06; C04B 14/106; C04B 14/30; C04B 16/0633; C04B 16/0641; C04B 18/146; C04B 24/383; C04B 24/405; C04B 41/4916; C04B 41/64; C04B 2103/302; C04B 2103/50; C04B 2103/54; C04B 2111/00181; C04B 2111/807

(57) ABSTRACT

A superhydrophobic self-luminous concrete material for 3D printing and a method for preparing the same, belonging to the field of building materials. The superhydrophobic self-luminous concrete includes: cement: 1000-1500 parts; quartz sand: 1000-1300 parts; silica fume: 50-100 parts; water: 300-400 parts; water reducing agent: 8-12 parts; cellulose ether: 1-2 parts; defoamer: 2-3 parts; fiber: 4-8 parts; luminous powder: 75-85 parts; reflective powder: 30-45 parts; metakaolin: 15-25 parts; metal filler: 0.015-0.040 parts; and a superhydrophobic coating. By combining 3D printing with the superhydrophobic self-luminous concrete material, the characteristics of energy saving, environment friendliness, high efficiency and low consumption of the 3D printing are highlighted, and the superhydrophobic self-luminous concrete material can be utilized to efficiently prepare fine and special-shaped components.

### CROSS-REFERENCE TO RELATED APPLICATIONS

The present invention claims the priority of Chinese patent application No. 202211077772.6, filed with China National Intellectual Property Administration on Sep. 5, 2022, and entitled “SUPERHYDROPHOBIC SELF-LUMINOUS CONCRETE MATERIAL FOR 3D PRINTING AND METHOD FOR PREPARING SAME”, the entire contents of which are incorporated into herein by reference.

### TECHNICAL FIELD

The present invention belongs to the field of building materials, and particularly relates to a superhydrophobic self-luminous concrete material for 3D printing and a method for preparing the same.

### BACKGROUND

The application of 3D printing technology in the field of construction engineering has gradually received widespread attention at home and abroad. Different from ordinary concrete, concrete for 3D printing for construction needs to have good thixotropy, that is, when this concrete is extruded, it gains good fluidity by mechanical vibration so as to facilitate printing, and after this concrete is extruded from the printing head, the mechanical vibration disappears, and the concrete immediately loses the fluidity and remains the shape to be printed. However, the current ordinary concrete or high-performance concrete for construction cannot meet this demand.

The synergistic design of the superhydrophobic surface coating and the self-luminous material can give a self-cleaning function to the surface of the self-luminous cement pavement material and improve the water resistance of the self-luminous cement pavement material. In particular, the superhydrophobic self-luminous material can play the role of indication, beautification and illumination in road signs, road dividers and sidewalks, thus being a typical energy-saving environmentally-friendly building decoration material. The superhydrophobic self-luminous material has long service life and stable luminous performance, and can effectively save power resources when used for low-brightness illumination, which is in line with the concept of green economic development of the society and has wide application prospects.

According to most of the existing methods for preparing superhydrophobic self-luminous concrete, cement, luminous powder and reflective powder are sufficiently preblended according to a certain ratio, and self-luminous concrete materials with ingredients in different ratios are prepared by changing the amounts of the luminous powder and the reflective powder. After the curing is completed, a hydrophobic material is applied as a coating to the surface of the self-luminous concrete. The traditional superhydrophobic self-luminous concrete requires long preparation time and complex operations, and can hardly be used for preparing fine and special-shaped components in construction.

### SUMMARY

In order to overcome the defects in the prior art, an object of the present invention is to provide a superhydrophobic self-luminous concrete material for 3D printing and a method for preparing the same. The concrete material provided by the present invention can be used for 3D printing, and can significantly improve the tensile strength and impact toughness of the material and enhance the luminous ability and reflective effect of the material.

In order to achieve the above object, the technical solutions of the present invention are as follows:

In one aspect, a superhydrophobic self-luminous concrete material for 3D printing includes a surface layer and a base layer.

The base layer includes the following ingredients in parts by weight:
cement: 1000-1500 parts;
quartz sand: 1000-1300 parts;
silica fume: 50-100 parts;
water: 300-400 parts;
water reducing agent: 8-12 parts;
cellulose ether: 1-2 parts;
defoamer: 2-3 parts;
fiber: 4-8 parts;
luminous powder: 75-85 parts;
reflective powder: 30-45 parts;
metakaolin: 15-25 parts; and
metal filler: 0.015-0.040 part.

The surface layer is a superhydrophobic coating.

In another aspect, a method for preparing a superhydrophobic self-luminous concrete material for 3D printing includes:
(1) proportionally weighing cement, quartz sand, silica fume, luminous powder, reflective powder, metakaolin and a metal filler, and uniformly mixing the mixture to obtain solid powder;
(2) proportionally weighing a water reducing agent, water, fiber, cellulose ether and a defoamer for later use;
(3) adding the water reducing agent and the water to the uniformly mixed solid powder, and stirring the mixture for 180-240 s;
(4) adding the fiber, the cellulose ether and the defoamer to the blend in (3), stirring the mixture for 300-600 s, and putting the mixture into a 3D printer to obtain self-luminous concrete, and
(5) applying a superhydrophobic coating to the self-luminous concrete specimen obtained in (4) to obtain the superhydrophobic self-luminous concrete.

The superhydrophobic coating is obtained by adding a fluorosilane material for fluorination during hydrolysis of tetraethyl orthosilicate.

The present invention has the following beneficial effects:

By combining 3D printing with the superhydrophobic self-luminous concrete material, the characteristics of energy saving, environment friendliness, high efficiency and low consumption of the 3D printing can be highlighted, and fine and special-shaped components that requires the properties of the superhydrophobic self-luminous concrete material in practical engineering can be prepared efficiently. The present invention improves mechanical properties of concrete such as tensile resistance, and has a high practical application value.

The concrete provided by the present invention can be used for 3D printing, and can significantly improve the tensile strength and impact toughness of the material and enhance the luminous ability and reflective effect of the material. Moreover, the concrete material provided by the present invention has the characteristics of short setting time and high early strength. The addition of the hydroxypropyl methyl cellulose ether can improve viscosity, extrudability and constructability. The addition of the metal filler Eu(DBM)₃phen can improve the tensile strength and impact strength of the concrete material, the tensile strength is improved by 2.45%, and the impact strength is improved by 11.97%. The metal filler is luminous, and can effectively improve mechanical properties of the material.

### DETAILED DESCRIPTION

It should be noted that, the following detailed descriptions are all exemplary, and are intended to provide further descriptions of the present invention. Unless otherwise specified, all technical and scientific terms used herein have the same meanings as those usually understood by an ordinary person skilled in the art to which the present invention belongs.

It should be noted that the terms used herein are merely used for describing specific embodiments, and are not intended to limit exemplary embodiments of the present invention. As used herein, the singular form is intended to include the plural form, unless the context clearly indicates otherwise. In addition, it should further be understood that terms “comprise” and/or “include” used in this specification indicate that there are features, steps, operations, devices, components, and/or combinations thereof.

In view of the problems of high requirements of the current 3D printing concrete technology for properties of concrete, long preparation time and complex operations of the superhydrophobic self-luminous concrete, and incapability of preparing fine and special-shaped components in construction, the present invention provides a superhydrophobic self-luminous concrete material for 3D printing and a method for preparing the same.

A typical embodiment of the present invention provides a superhydrophobic self-luminous concrete material for 3D printing, including a surface layer and a base layer.

The base layer includes the following ingredients in parts by weight:
cement: 1000-1500 parts;
quartz sand: 1000-1300 parts;
silica fume: 50-100 parts;
water: 300-400 parts;
water reducing agent: 8-12 parts;
cellulose ether: 1-2 parts;
defoamer: 2-3 parts;
fiber: 4-8 parts;
luminous powder: 75-85 parts;
reflective powder: 30-45 parts;
metakaolin: 15-25 parts; and
metal filler: 0.015-0.040 part.

The surface layer is a superhydrophobic coating.

In some examples of this embodiment, the base layer includes the following ingredients in parts by weight:
cement 1000-1200 parts;
quartz sand: 1000-1100 parts;
silica fume: 50-55 parts;
water: 340-380 parts;
water reducing agent: 10-12 parts;
cellulose ether: 1-1.2 parts;
defoamer: 2-2.5 parts;
fiber: 4-6 parts;
luminous powder: 75-80 parts;
reflective powder: 30-40 parts;
metakaolin: 15-20 parts; and
metal filler: 0.016-0.032 part.

In some examples of this embodiment, the cement includes 82-100 wt % of ordinary Portland cement and 0-18 wt % of sulfoaluminate cement. Preferably, the ordinary Portland cement is of grade 42.5, and the sulfoaluminate cement is of grade 52.5. The mixture of the two types of cement can ensure the material to have high early strength and age strength.

In some examples of this embodiment, the water reducing agent is a polycarboxylic acid water reducing agent, which has a water reducing rate of 32% and is used for regulating the fluidity and extrudability of the material.

In some examples of this embodiment, the cellulose ether is hydroxypropyl methyl cellulose ether having a viscosity of 200 Pa·s, and as a viscosity modifier, can improve the extrudability and constructability.

In some examples of this embodiment, the fiber includes polypropylene fiber and polyvinyl alcohol fiber.

Preferably, the polypropylene fiber has a length-to-diameter ratio of 110-130, preferably 120.

Preferably, the polyvinyl alcohol fiber has a length-to-diameter ratio of 190-200, preferably 194.

Preferably, the polypropylene fiber has a diameter of 40-60 μm, preferably 50 μm.

Preferably, the polyvinyl alcohol fiber has a diameter of 30-40 μm, preferably 31 μm.

Preferably, a mass ratio of the polypropylene fiber to the polyvinyl alcohol fiber is 1-5:1-2, preferably 4:1.

The addition of the fiber to the concrete material can improve the toughness of the material, such that the material is suitable for 3D printing technology.

In some examples of this embodiment, the metal filler is Eu(DBM)₃phen. The luminous organometallic complex Eu(DBM)₃phen is used as a filler to modify the concrete material, and can further improve the self-luminous ability of concrete and the tensile strength and impact strength of the material.

Preferably, a mass ratio of the metal filler to the polypropylene fiber is 0.5-1:99.0-99.5, preferably 0.5:99.5. The metal filler and the polypropylene fiber synergically improve the mechanical properties of the concrete material. Moreover, when the metal filler and the polypropylene fiber are added according to this mass ratio, the tensile strength and impact strength of the concrete material are greatly improved.

In some examples of this embodiment, the luminous powder is rare earth greenish-yellow luminous powder, preferably SrAl₂O₄:Eu²⁺,Dy³⁺, and has a particle size of 500-700 mesh, preferably 600 mesh. The addition of the luminous powder can prolong the self-luminous time of the concrete material, and the afterglow time can reach more than 8 h with respect to the minimum visible brightness of human eyes 0.32 med/m².

In some examples of this embodiment, the reflective powder is gray reflective powder with glass as the main powder material, the main chemical component of which is SiO₂. The reflective powder has a particle size of 200 mesh. After being added, the reflective powder can make the concrete material have a retroreflective effect by utilizing the high refractiveness of microbeads.

In some examples of this embodiment, the metakaolin is obtained by calcination of kaolin at 850° C. The main chemical components of the metakaolin are SiO₂ and Al₂O₃. The metakaolin can significantly improve the static yield stress of the material and reduce the structural deformation.

In some examples of this embodiment, the superhydrophobic coating is obtained by adding a fluorosilane material for fluorination during hydrolysis of tetraethyl orthosilicate, and is preferably a fluorosilane hydrophobic coating.

Another typical embodiment of the present invention provides a method for preparing a superhydrophobic self-luminous concrete material for 3D printing described above, including:
(1) proportionally weighing cement, quartz sand, silica fume, luminous powder, reflective powder, metakaolin and a metal filler, and uniformly mixing the mixture to obtain solid powder;
(2) proportionally weighing a water reducing agent, water, fiber, cellulose ether and a defoamer for later use;
(3) adding the water reducing agent and the water to the uniformly mixed solid powder, and uniformly stirring the mixture;
(4) adding the fiber, the cellulose ether and the defoamer to the blend in (3), uniformly stirring the mixture, and putting the mixture into a 3D printer to obtain self-luminous concrete; and
(5) applying a superhydrophobic coating to the self-luminous concrete specimen obtained in (4) to obtain the superhydrophobic self-luminous concrete.

The superhydrophobic coating is obtained by adding a fluorosilane material for fluorination during hydrolysis of tetraethyl orthosilicate.

In some examples of this embodiment, the time of stirring may be flexibly adjusted according to the specific mixture ratio of the material.

Preferably, the stirring in (3) is carried out for 180-240 s.

Preferably, the stirring in (4) is carried out for 300-600 s.

In order to make those skilled in the art understand the technical solutions of the present invention more clearly, the technical solutions of the present invention will be described in detail in conjunction with specific examples.

The polypropylene fiber used in the following examples has a length-to-diameter ratio of 120 and a diameter of 50 μm; and the polyvinyl alcohol fiber has a length-to-diameter ratio of 194 and a diameter of 31 μm. The superhydrophobic coating used in the following examples is a commercially available fluorosilane hydrophobic coating.

### Example 1

### Method for Preparing Superhydrophobic Self-Luminous Concrete Material for 3D Printing

The superhydrophobic self-luminous concrete material for 3D printing includes the following ingredients in parts by weight: 1000 parts of 42.5 ordinary Portland cement, 180 parts of 52.5 sulfoaluminate cement, 1000 parts of quartz sand, 50 parts of silica fume, 340 parts of water, 10 parts of polycarboxylic acid water reducing agent, 1 part of hydroxypropyl methyl cellulose ether, 2 parts of defoamer, 3.2 parts of polypropylene fiber, 0.8 part of polyvinyl alcohol fiber, 75 parts of luminous powder, 30 parts of reflective powder, 15 parts of metakaolin and 0.016 part of metal filler Eu(DBM)₃phen.

The method for preparing a superhydrophobic self-luminous concrete material for 3D printing includes the following steps:
(1) Cement, quartz sand, silica fume, luminous powder, reflective powder, metakaolin and a metal filler were proportionally weighed, and uniformly mixed to obtain solid powder.
(2) A water reducing agent, water, fiber, cellulose ether and a defoamer were proportionally weighed for later use.
(3) The water reducing agent and the water were added to the uniformly mixed solid powder, and the mixture was stirred for 180-240 s.
(4) The fiber, the cellulose ether and the defoamer were added to the blend, and the mixture was stirred for 300-600 s, and put into a 3D printer to obtain self-luminous concrete.
(5) A superhydrophobic coating was applied to the self-luminous concrete specimen to obtain the superhydrophobic self-luminous concrete.

### Example 2

### Method for Preparing Superhydrophobic Self-Luminous Concrete Material for 3D Printing

The superhydrophobic self-luminous concrete material for 3D printing includes the following ingredients in parts by weight: 1000 parts of 42.5 ordinary Portland cement, 180 parts of 52.5 sulfoaluminate cement, 1000 parts of quartz sand, 50 parts of silica fume, 340 parts of water, 10 parts of polycarboxylic acid water reducing agent, 1 part of hydroxypropyl methyl cellulose ether, 2 parts of defoamer, 3.2 parts of polypropylene fiber, 0.8 part of polyvinyl alcohol fiber, 75 parts of luminous powder, 30 parts of reflective powder, 15 parts of metakaolin and 0.032 part of metal filler Eu(DBM)₃phen.

The method for preparing a superhydrophobic self-luminous concrete material for 3D printing includes the following steps:
(1) Cement, quartz sand, silica fume, luminous powder, reflective powder, metakaolin and a metal filler were proportionally weighed, and uniformly mixed to obtain solid powder.
(2) A water reducing agent, water, fiber, cellulose ether and a defoamer were proportionally weighed for later use.
(3) The water reducing agent and the water were added to the uniformly mixed solid powder, and the mixture was stirred for 180-240 s.
(4) The fiber, the cellulose ether and the defoamer were added to the blend, and the mixture was stirred for 300-600 s, and put into a 3D printer to obtain self-luminous concrete.
(5) A superhydrophobic coating was applied to the self-luminous concrete specimen to obtain the superhydrophobic self-luminous concrete.

### Comparative Example 1

This comparative example was different from Example 1 in that no metal filler Eu(DBM)₃phen was added.

### Comparative Example 2

This comparative example was different from Example 1 in that no polypropylene was added. This concrete had low formability.

### Mechanical Properties Testing:

The superhydrophobic self-luminous concrete materials obtained by the methods in Examples 1 to 2 and Comparative Examples 1 and 3 to 4 were tested for the influence of the metal filler on mechanical properties of polypropylene. The results are shown in Table 1 below.

TABLE 1

| | Mass percentages of addition | Tensile | Impact |
|---|---|---|---|
| | amount of polypropylene and | strength/ | strength/ |
| | metal filler | MPa | KJ/m² |
| Example 1 | Polypropylene:metal filler = | 33.324 | 8.612 |
| | 99.5%:0.5% | | |
| Example 2 | Polypropylene:metal filler = | 33.078 | 7.726 |
| | 99%:1% | | |
| Comparative | Polypropylene 100% | 32.527 | 7.691 |
| Example 1 | | | |

As can be seen from Table 1, when the mass percentages of addition amount of polypropylene and metal filler is polypropylene:metal filler=99.5%:0.5%, the superhydrophobic self-luminous concrete material has the best mechanical properties. Compared with the mechanical properties of the superhydrophobic self-luminous concrete material in which no metal filler is added, the tensile strength is improved by 2.45%, and the impact strength is improved by 11.97%. As a result, the addition of the metal filler Eu(DBM)₃phen can improve the tensile strength and impact strength of the concrete material. The metal filler is luminous, and can effectively improve the mechanical properties of the material

### Initial Setting Time and Final Setting Time Testing:

The superhydrophobic self-luminous concrete materials obtained by the methods in Examples 1 to 2 and Comparative Examples 1 and 3 to 4 were tested for their initial setting time and final setting time. The results show that the initial setting time of the superhydrophobic self-luminous concrete is 20-120 min, and the final setting time is 60-180 min.

The foregoing descriptions are merely preferred examples of the present invention, but are not intended to limit the present invention. A person skilled in the art may make various alterations and variations to the present invention. Any modification, equivalent replacement, or improvement made and the like within the spirit and principle of the present invention shall fall within the protection scope of the present invention.

1. A superhydrophobic self-luminous concrete material for 3D printing, comprising a surface layer and a base layer; wherein
the base layer comprises the following ingredients in parts by weight:
cement: 1000-1500 parts;
quartz sand: 1000-1300 parts;
silica fume: 50-100 parts;
water: 300-400 parts;
water reducing agent: 8-12 parts;
cellulose ether: 1-2 parts;
defoamer: 2-3 parts;
fiber: 4-8 parts;
luminous powder: 75-85 parts;
reflective powder: 30-45 parts;
metakaolin: 15-25 parts; and
metal filler: 0.015-0.040 part;
the surface layer is a superhydrophobic coating;
the fiber comprises polypropylene fiber and polyvinyl alcohol fiber; a mass ratio of the metal filler to the polypropylene fiber is 0.5-1:99.0-99.5;
the metal filler is Eu(DBM)₃phen; and
the luminous powder is rare earth greenish-yellow luminous powder SrAl₂O₄:Eu²⁺,Dy³⁺.

2. The superhydrophobic self-luminous concrete material for 3D printing according to claim 1, wherein the base layer comprises the following ingredients in parts by weight:
cement: 1000-1200 parts;
quartz sand: 1000-1100 parts;
silica fume: 50-55 parts;
water: 340-380 parts;
water reducing agent: 10-12 parts;
cellulose ether: 1-1.2 parts;
defoamer: 2-2.5 parts;
fiber: 4-6 parts;
luminous powder: 75-80 parts;
reflective powder: 30-40 parts;
metakaolin: 15-20 parts; and
metal filler: 0.016-0.032 part.

3. The superhydrophobic self-luminous concrete material for 3D printing according to claim 1, wherein the cement comprises 82-100 wt % of Portland cement and 0-18 wt % of sulfoaluminate cement.

4. The superhydrophobic self-luminous concrete material for 3D printing according to claim 1, wherein the polypropylene fiber has a length-to-diameter ratio of 110-130.

5. The superhydrophobic self-luminous concrete material for 3D printing according to claim 4, wherein the polypropylene fiber has a length-to-diameter ratio of 120.

6. The superhydrophobic self-luminous concrete material for 3D printing according to claim 1, wherein the polyvinyl alcohol fiber has a length-to-diameter ratio of 190-200.

7. The superhydrophobic self-luminous concrete material for 3D printing according to claim 6, wherein the polyvinyl alcohol fiber has a length-to-diameter ratio of 194.

8. The superhydrophobic self-luminous concrete material for 3D printing according to claim 1, wherein the polypropylene fiber has a diameter of 40-60 μm.

9. The superhydrophobic self-luminous concrete material for 3D printing according to claim 8, wherein the polypropylene fiber has a diameter of 50 μm.

10. The superhydrophobic self-luminous concrete material for 3D printing according to claim 1, wherein the polyvinyl alcohol fiber has a diameter of 30-40 μm.

11. The superhydrophobic self-luminous concrete material for 3D printing according to claim 10, wherein the polyvinyl alcohol fiber has a diameter of 31 μm.

12. The superhydrophobic self-luminous concrete material for 3D printing according to claim 1, wherein a mass ratio of the polypropylene fiber to the polyvinyl alcohol fiber is 4:1.

13. The superhydrophobic self-luminous concrete material for 3D printing according to claim 1, wherein the mass ratio of the metal filler to the polypropylene fiber is 0.5:99.5.

14. The superhydrophobic self-luminous concrete material for 3D printing according to claim 1, wherein the luminous powder has a particle size of 500-700 mesh.

15. The superhydrophobic self-luminous concrete material for 3D printing according to claim 14, wherein the luminous powder has a particle size of 600 mesh.

16. The superhydrophobic self-luminous concrete material for 3D printing according to claim 1, wherein the superhydrophobic coating is obtained by adding a fluorosilane material for fluorination during hydrolysis of tetraethyl orthosilicate.

17. The superhydrophobic self-luminous concrete material for 3D printing according to claim 16, wherein the superhydrophobic coating is a fluorosilane hydrophobic coating.

18. A method for preparing a superhydrophobic self-luminous concrete material for 3D printing according to claim 1, comprising the following steps:
(1) proportionally weighing cement, quartz sand, silica fume, luminous powder, reflective powder, metakaolin and a metal filler, and uniformly mixing the mixture to obtain solid powder;
(2) proportionally weighing a water reducing agent, water, fiber, cellulose ether and a defoamer for later use;
(3) adding the water reducing agent and the water to the uniformly mixed solid powder, and uniformly stirring the mixture;
(4) adding the fiber, the cellulose ether and the defoamer to the blend in (3), uniformly stirring the mixture, and putting the mixture into a 3D printer to obtain self-luminous concrete; and
(5) applying a superhydrophobic coating to the self-luminous concrete specimen obtained in (4) to obtain the superhydrophobic self-luminous concrete;
wherein the superhydrophobic coating is obtained by adding a fluorosilane material for fluorination during hydrolysis of tetraethyl orthosilicate.

19. The method for preparing a superhydrophobic self-luminous concrete material for 3D printing according to claim 18, wherein the stirring in (3) is carried out for 180-240 s.

20. The method for preparing a superhydrophobic self-luminous concrete material for 3D printing according to claim 18, wherein the stirring in (4) is carried out for 300-600 s.
